(19) United States
(12) Patent Application Publication
(10) Pub. No.: US 2011/0154890 A1
(43) Pub. Date: Jun. 30, 2011

(54) SEPARATION OF PARTICLES IN LIQUIDS BY USE OF A STANDING ULTRASONIC WAVE

(75) Inventors: Claus Holm, Copenhagen (DK); Jacob Riis Folkenberg, Hillerod (DK); Carl Johan Grenvall, Lund (SE); Lars Thomas Laurell, Lund (SE); Per Augustsson, Lund (SE)

(73) Assignee: Foss Analytical A/S, Hileroed (DK)

(21) Appl. No.: 12/737,991

(22) PCT Filed: Oct. 8, 2008
(86) PCT No.: PCT/EP2008/063434

§ 371 Date: Mar. 8, 2011

(51) Int. Cl. G01N 29/02

(52) U.S. Cl. 73/61.75

(57) ABSTRACT

The invention relates to a device for manipulation of particles (30) in a sample liquid (32) said device comprising a source of ultrasound (16) capable of emitting ultrasound with a given wavelength, an inlet for a sample liquid (2), one or more outlets (4, 5, 6) and a compartment (14), being dimensioned to support a standing ultrasonic wave (40) of said wavelength, characterised in that the device further comprises an inlet for sheath liquid (1, 3) configured to direct a sheath liquid (34) to extend substantially in parallel to an anti-node plane (46) of the ultrasonic standing wave (40) proximate to a sheathed compartment wall. Specifically the device may be used in combination with a particle enumeration device for enumeration of somatic cells in milk.

### TECHNICAL FIELD OF THE INVENTION

The current invention relates to the manipulation, sorting and detection of particles in a sample liquid, such as somatic cells in milk.

In the production of food it is essential to analyse the food contents all the way from the raw materials to the finished products. This is required to monitor and optimize the production, and to ensure the quality of the raw materials as well as the finished products.

When analysing liquid food products, the presence of particles in the sample after filtering may pose particular problems. E.g. the largest fat particles in milk lead to significant light scattering, which makes microscopy unsuited for milk samples and gives rise to transmission losses in infrared spectroscopy of milk. In this case, a simple way of removing the fat particles could facilitate new methods of analysis, higher efficiency of spectroscopic techniques or measurements of components otherwise masked by the presence of fat particles.

In other types of analysis, the presence of specific particles must be characterized or counted—i.e. somatic cells or bacteria in milk, yeast cells in wine and beer or fruit pulp and other particles in fruit juice.

In order to remove interfering particles a chemical is typically added in a pre-treatment step before the actual sample analysis, or a labelling molecule is added in order to enhance the signal from the particles that need to be characterised or counted. The addition of such chemicals is in principle unwanted. It adds to the cost and complexity of the analysis and working with some of the added substances may pose a health threat. A method for separation of the particles, which may limit or completely remove the need for added substances, will therefore be a major advantage in many types of liquid food analysis.

### STATE-OF-THE-ART

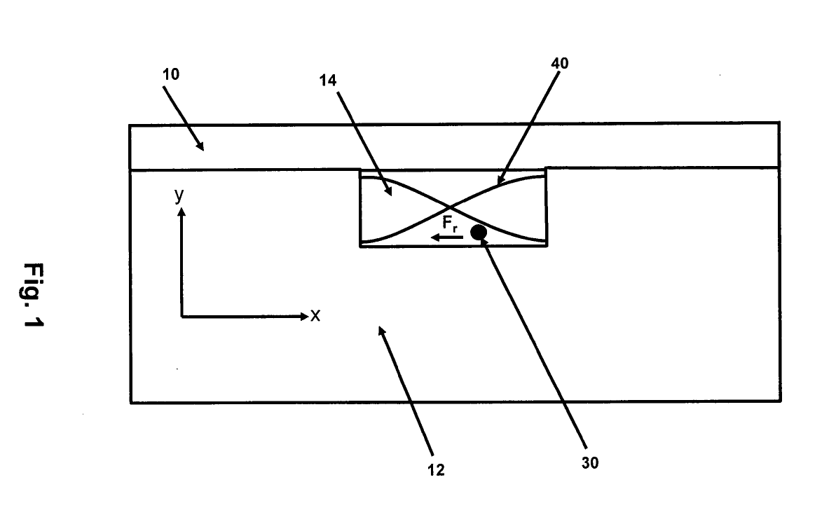

A method of particle separation in a liquid according to the physical properties of the particles by use of ultrasound called acoustophoresis, is practiced in the treatment of blood, where it is desired to remove fat globules. One way of doing this is disclosed in EP 1365849 B (T. LAURELL ET. AL.) Mar. 3, 2003 where ultrasonic standing waves are employed to manipulate particles by driving them towards the pressure nodes in an ultrasonic standing wave. The direction of the force Fᵣ upon a particle 30 is mainly defined by the density and the compressibility of the particle as shown in the following equation, for a standing wave 40 in a rectangular channel 14, as illustrated in FIG. 1.

$$\begin{matrix}{F}_{r } = - ( \frac{π {p}_{0}^{2} {V}_{c} {β}_{w}}{2 λ} ) \cdot φ ( β , ρ ) \cdot sin ( 2 kx ) & ( 1 ) \\ φ ( β , ρ ) = \frac{5 {ρ}_{c} - 2 {ρ}_{w}}{2 {ρ}_{c} + {ρ}_{w}} - \frac{{β}_{c}}{{β}_{w}} & \end{matrix}$$

The effect of the force is that particles that have a positive φ will move towards the node of the standing wave pattern, and particles that have a negative φ will move towards the anti-nodes. As a result particles with a low density ρ_{c} and/or a high compressibility β_{c} (relative to the liquid) will be concentrated at anti-nodes of the standing wave, and the more dense and less compressible particles will be concentrated at the nodes of the standing wave, thus enabling a separation of particles. The other symbols in Equation 1 are the particle volume, V_{c}, the ultrasound pressure amplitude, p₀, the ultrasound wavelength (wavenumber), λ(k), and the density and compressibility of the liquid, ρ_{w} and β_{w}. The terms node and anti-node henceforth refers to the standing wave pressure node and pressure anti node, and the term focussing nodes shall be taken to refer to anti nodes and nodes collectively.

In a system where the cross section of a flow channel is λ/2, low density fat globules will be moved towards the anti-node at the outer wall, whereas heavier particles such as biological cells will be moved towards the node at the centre of the flow channel. A separation of the flow in a centre channel and outer channels will thus allow a separation of a flow with increased concentration of cells in the centre and a flow with increased concentration of fat globules near the walls. However, the fat globules at the wall will tend to stick to the wall and coalesce, eventually at the risk of blocking or disturbing the flow.

### THE INVENTION

The present invention is intended to reduce the sensitivity towards the presence of fat globules and other low density particles and to reduce the requirements for reagents in particle detection and counting devices, by employing the known technique of acoustophoresis in a novel and inventive way. The novel principle is based on the use of a sheath liquid separating a liquid containing particle from the walls of the flow channel in combination with a particular order of the standing wave pattern and a particular ratio of the sheath liquid to sample liquid flow rates. In this way the drawbacks of particles blocking or disturbing the flow, is removed or significantly reduced, which will contribute to reducing the amount of reagents added in technologies for counting biological cells.

The flow channels that typically have been used in the prior art have a width corresponding to half the wavelength of the ultrasound wave, the so-called fundamental resonance, which means that the anti-node is located at or close to the channel walls, and the node is located in the middle of the channel. The only equilibrium position of low density particles, such as fat globules, is thus at the side walls. If a higher order standing wave is excited, corresponding to a channel width of two, three or four half wavelengths, one or more anti-nodes will also be located in the channel. This means that low density particles will have equilibrium positions inside the channel, away from the walls.

In the following discussion we will use the terms anti-node plane and node plane, to denote the surfaces along the flow direction where particles with either positive or negative φ will be attracted to. The term focussing plane will be used as a general term for either the anti-node plane or node plane.

The invention will be described in further detail in the following with reference to the figures of which

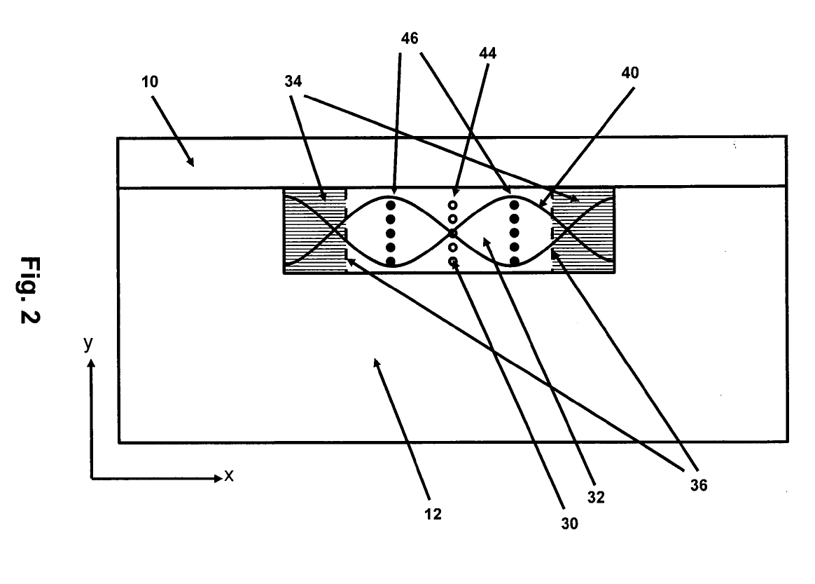

FIGS. 1 and 2 are cross sectional views of the invention and

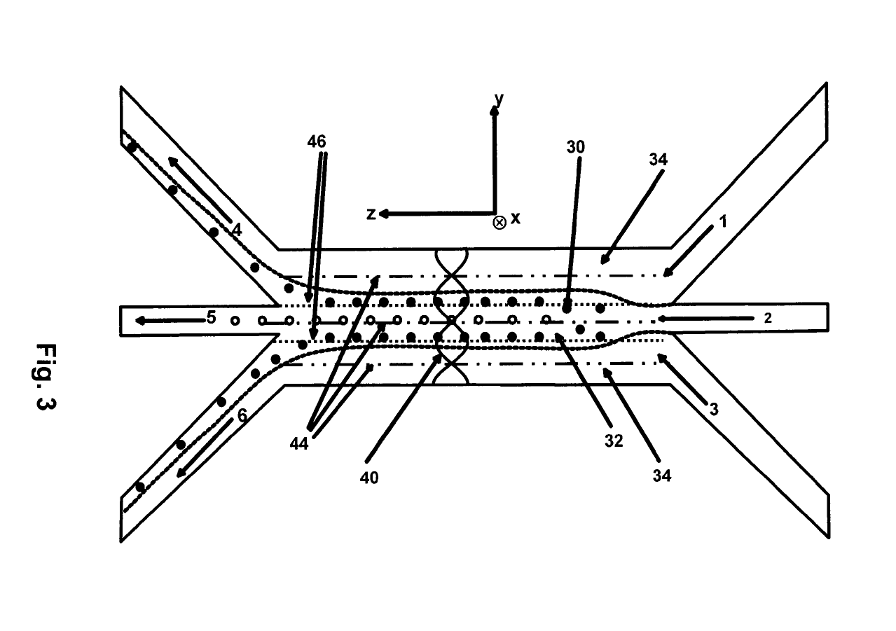

FIG. 3 is a top view all serving to describe the principles of the invention and

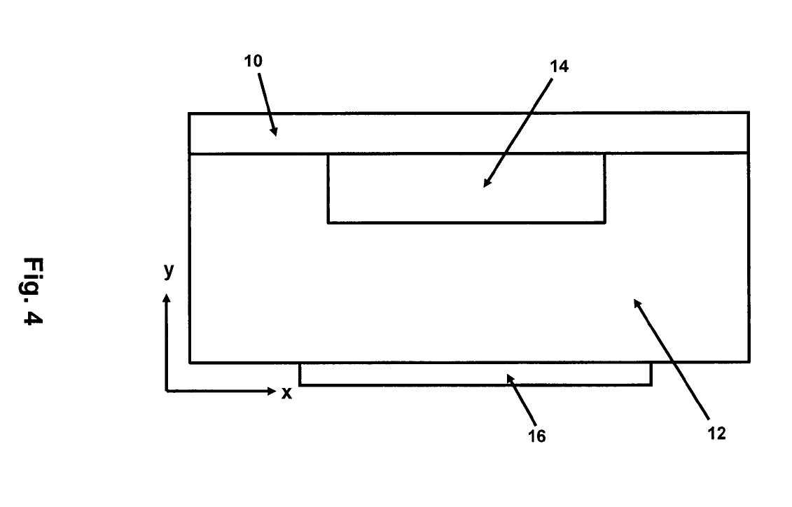

FIG. 4 is a cross sectional view describing the elements of the invention.

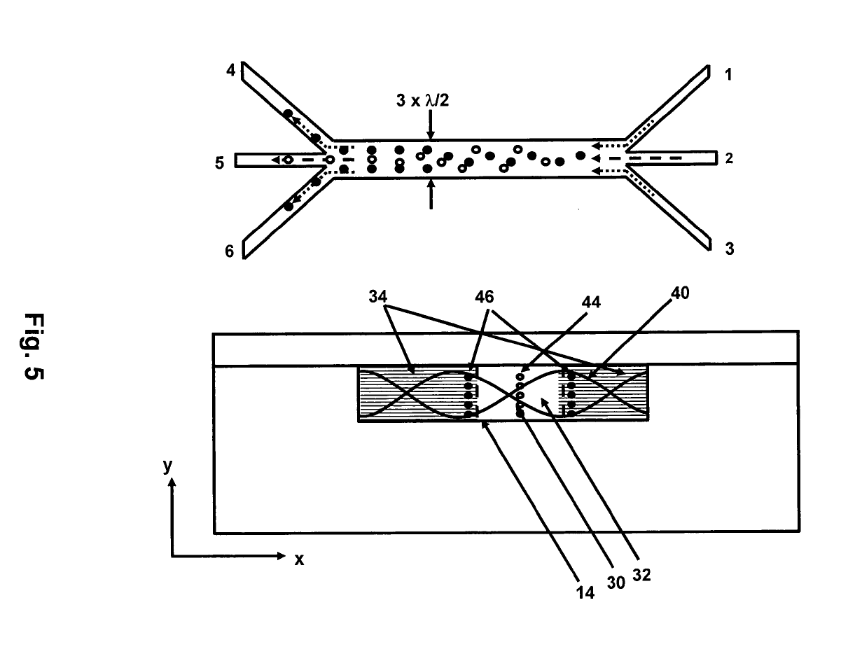

FIGS. 5, 6, 7 and 8 each show specific embodiments of the invention.

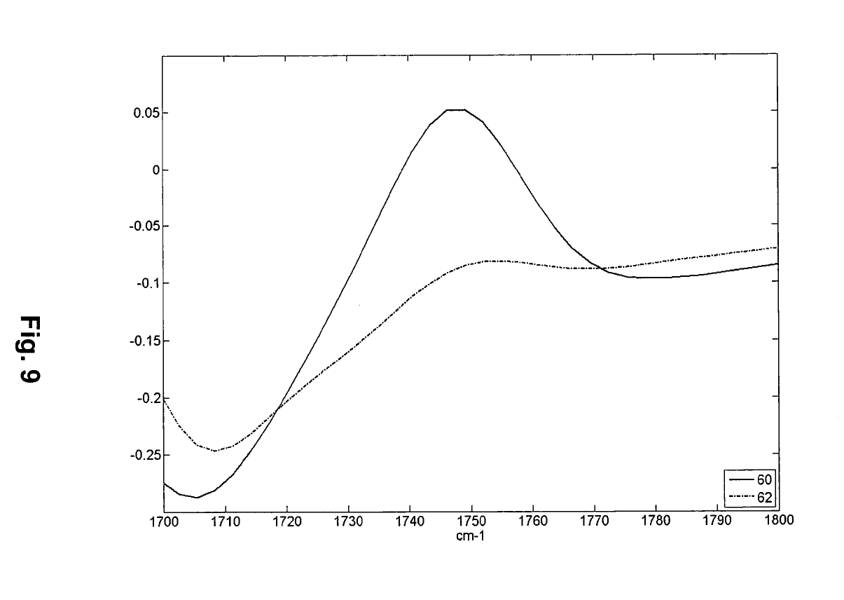

FIGS. 9 through 14 demonstrates the invention by showing experimental results based on the invention.

To exploit the full potential of a specific order of the standing wave, a sheath liquid 34 may also have to be present between the sample liquid 32 and the side walls, for example as shown in FIG. 2. The sheath liquid 34 does not contain any particles 30 to be moved and may serve one or more of the purposes described in the following.

Firstly, the amount of sheath liquid 34 defines the position of the interface between the sheath liquid 34 and sample liquids 32. To avoid particles 30 in the sample liquid 32 having a low density from reaching the channel wall, the interface 36 must be further away from the walls than the first node plane 46.

Secondly, the sheath liquid prevents particles from sticking to the channel walls. This may be accomplished by adding a detergent to the sheath liquid or, in the case of fat particles, to use a non-polar sheath liquid in which the fat particles are soluble. Finally, if a sheath liquid, that has a lower density than particles is used, the sign of φ is reversed such that the particles are actually repelled from the channel wall. In the latter case, a channel width corresponding to half a wavelength could still be used.

A successful use of sheath liquid in ultrasonic particle manipulation system requires a stable laminar flow secured by a proper choice of sheath liquid density. It has been found experimentally that if the sample liquid is centred in a channel with an anti-node plane in the middle, the sheath liquid must have the same or a higher density than the sample liquid. Otherwise, the ultrasound may force the sheath and sample liquid to mix or exchange positions, unless the difference in density is fairly low; i.e. less than 10%, in which case a pseudo stable flow may be obtained.

The position of the interface between the buffer and sample liquids is controlled by the relative flow rates into the microchannel. The selective collection of one or the other type of particles is achieved by branching out the microchannel at the output, and controlling the flow rate in each of these branches. Furthermore, the order of the acoustic standing wave pattern in the channel determines the position of the separated particles in the channel.

The principle for controlling the liquid interface and the selective collection of particles is shown in FIG. 3, which is a topview of a microchannel with a sample liquid inlet branch 2, two sheath liquid inlet branches 1 and 3 and three outlet branches 4, 5 and 6. The corresponding flowrates are denoted Q₁-Q₆. The width of the channel corresponds to 3×λ/2. The liquid flowing out of branch 5 consists mainly of the sample liquid containing the high density particles moved to the centre node plane 44, but without the lower density particles that have been moved to the anti-node plane 46. The particles at the anti-node plane 46 flows out through the branches 4 and 6, together with the sheath liquid 34.

Assuming the liquids are incompressible, the law of mass conservation demands that Qₜₒₜ=Q₁+Q₂+Q₃=Q₄+Q₅+Q₆. To illustrate the principle of flow control in the system, we may for simplicity assume that Q₁=Q₃ if the microchannels are symmetric. The ratio rᵢₙ=Q₂/Q₁ now determines the position of the liquid interface in the channel—if rᵢₙ>>1 the sample liquid will fill out most of the channel, and the interface is close to the channel wall, and likewise if rᵢₙ<<1 the interface is close to the center of the channel. It is noted however, that there is in general no simple relation between the value of rᵢₙ and the position of the interface in the channel. Due to the boundary conditions at the channel walls, the flow velocity approaches zero here and has a maximum in the center of the channel. Furthermore, the actual interface between the liquids may not be a straight plane, but rather a curved shape due to the contact angle between the two liquids and the channel wall material. Thus, the total flow rate of one of the liquids is more precisely an integral over the velocity profile, given by equation (2).

$${Q}_{i} = {\int }_{C}^{ } v ( x , y ) d x d y \qquad ( 2 )$$

Here, C is the cross sectional area of the liquid, i, in the xy-plane of the channel.

On the output side we may likewise define rₒᵤₜ=Q₅/Q₄ and assume that Q₄ and Q₅ are adjusted such that Q₄=Q₆ and that the system is symmetrical. If rₒᵤₜ<<1, only the fraction of the liquids closest to the centre of the channel will flow into branch 5 and the rest of the liquids flow into branch 4 and 6. Clearly, to obtain a separation of the particles shown in FIG. 3 into different branches, the value of rₒᵤₜ must not be too high—otherwise both types of particles go into branch 5.

To obtain the highest possible separation efficiency, it is necessary to maximize the action of the acoustic force. This may be obtained by increasing the acoustic pressure amplitude, but eventually detrimental sample heating or even fracturing of the channel will occur. A higher frequency of the ultrasonic source will also give an increased separation force according to Equation 1, especially in the range up to 10 MHz until the channel supporting a standing wave become too narrow to be practical or the ultrasound attenuation becomes very high. This relation between force and frequency also means that frequencies lower than 100 kHz will generate too low an acoustic pressure to be suitable for acoustic separation. Another approach to increasing separation efficiency is to stop the flow or decrease the sample flow rate or increase the length of the channel, such that the particles have more time to move to their equilibrium positions.

### Design of Microfluid Structures

In FIG. 4 is shown a typical cross section of a microfluid channel 14. The channel is etched into a base material 12 such as silicon using e.g. conventional etching techniques known from the microelectronics industry. The channel is capped with a glass lid 10 which may be attached using anodic bonding. The ultrasound transducer 16 is a piezo element placed in acoustic cooling with the channel, and driven at the required frequency, given by f=c/λ, where c is the ultrasound velocity in the media and λ is the ultrasound wavelength that yields the desired pattern of nodes and anti-nodes in the channel.

The position of the ultrasound transducer is not critical, as long as the coupling of the ultrasound into the channel is efficient. E.g. the transducer may be placed at the side or even on top of the microfluid system. A contact material between the transducer and the microchannel is required to match the acoustic impedances of the transducer and the material in the microfluid system. A variety of transducers are suitable for use in the invention, such as piezoceramic, piezosalt, piezopolymer, piezocrystal, magnetostrictive, and electromagnetic transducers.

An important property of the base material in which the channel is formed, is a sufficiently low ultrasonic attenuation, such that the ultrasound can propagate from the transducer to the channel. Other materials than silicon, such as glass or crystalline materials like GaAs, InP, CaF₂ or sapphire may be chosen. Of particular interest for integration with microscope imaging are materials that are also transparent to visible light, such as most types of glasses. For integration with spectroscopy, materials transparent to the specific spectroscopic wavelength being used are preferred, such as for near-infrared light silica or sapphire, or for infrared light, CaF₂, Ge or ZnSe.

Equation 1 and the considerations regarding the position of node planes and anti-node planes are given under the assumption of a rectangular flow channel cross section. However, as disclosed in [M. Evander et al, Anal. Chem., 2008, 80 (13), 5178-5185] the separation principle is robust towards variation in the wall shape and the placement of the ultrasonic source.

In practice, most cross sectional shapes of the channel will support a standing wave at some resonance frequency, even if the walls are not parallel. If the shape is characterized by one direction being significantly longer than the perpendicular direction, the lowest frequency resonance will generate a standing wave pattern extending primarily along the longest direction. The equilibrium positions of particles subjected to the acoustic force in such a channel will be located in concentrating planes approximately perpendicular to the longest direction, and the concentrating planes will still resemble geometrical planes. The lowest resonance frequency—the so-called fundamental resonance—will give rise to a standing wave pattern with one node plane in the channel. The first higher order resonance will give rise to two node planes in the channel, the second higher order resonance will give rise to three node planes in the channel and so on.

If the shape of the channel cross section is not characterized by one direction being significantly longer than the perpendicular direction, e.g. a square or circular shape, a standing wave pattern can still be generated, but the shape of the concentrating planes may no longer resemble an unconnected geometrical plane, but may instead be e.g. a cylindrical surface in a circular channel. Dependent on the position and power of the ultrasonic source, and the properties of the base material more complex standing wave patterns may also be stable in a compartment with a close to regular cross-section.

### EXEMPLARY EMBODIMENTS

In following a number of embodiments will be presented, with their respective benefits in relation to the subclaims.

In a first embodiment of the invention a flow of sample liquid, such as milk, is separated from a compartment wall by a flow of sheath liquid. The sample liquid will contain two types of particles; low density particles such as fat globules and high density particles such as somatic cells. The compartment is connected to a source of ultrasound in a way causing a transfer of ultrasound to the liquid, such as on the side or on the top of the compartment and the size and shape of the compartment must support to a fundamental or higher order ultrasonic standing wave with a channel width corresponding to a whole multitude of λ/2, i.e. it must have a width of approximately n·λ/2 (n=1, 2, 3 . . . ) and a height less than λ/2. In this case the fat globules in the milk will be driven towards the anti-node planes and the cells in the milk towards the node planes. This embodiment may operate with a standstill of the liquids, causing a better separation or with all liquids flowing, and the compartment functioning as a flow channel, according to claim 4, causing the benefit of a more rapid separation.

The geometry of the compartment or the flow channel will typically involve a length, which is at least a factor 5 of the wavelength, to avoid a risk of standing waves in the lengthwise direction. The width must as mentioned correspond to an approximate multiplicity of n·λ/2 (n=1, 2, 3 . . . ) and the height must either be less than λ/2 or similar to the width. In the first case, of a flat compartment which is significantly wider than high a standing wave will have focussing planes which have the nature of unconnected planes; i.e. the node planes will be sheets which will be substantially parallel, possibly with small deviations from parallel due to irregular shapes of the compartment walls, and variations in ultrasound propagation. In the second case, the compartment has similar width and height, e.g. with a square or circular cross sectional shape, and is said to have a regular cross sectional geometry. In this case the focussing nodes of the standing wave may have several stable configurations. As an example a circular tubular flow channel is considered. In this case a standing wave with an appropriate wavelength exists, where the focussing planes will be positioned as concentric tubular surfaces. For other approximately regular cross sections a similar set of substantially concentric focussing planes will exist, but for certain shapes multiple disconnected focussing planes may also exist, since multiple stable configurations of the focussing planes may exist.

In a list of embodiments corresponding to the options for the channel dimensions and accordingly the order of the standing wave the benefits of various geometries and the requirements to the sheath liquid are demonstrated.

In one embodiment, shown in FIG. 5, the width of the channel 14 corresponds to three half wavelengths (a second order standing wave 40), such that two anti-node planes 46 are located inside the channel. There are three inlets 1, 2, and 3 and three outlets 4, 5, and 6, symmetrically arranged around the centre of the channel. The sample liquid 32 is raw milk and the sheath liquid 34 has the same or a lower density than the milk, this could for instance be pure water. The sample and sheath liquid flow rates at the inlet are adjusted such that the sample liquid does not extend beyond the two anti-node planes 46 inside the channel. The fat particles in the milk will be drawn towards the two anti-node planes 46 inside the channel, and the somatic cells will be drawn towards the central node plane 44. By a proper adjustment of the outlet flow rates Q₄ Q₅ and Q₆, the sample liquid containing the somatic cells and with a reduced amount of fat particles can be directed into the central outlet. If the flow rate in the central outlet Q₅ is smaller than the sample liquid flow rate at the inlet Q₂, it is possible to concentrate the somatic cells.

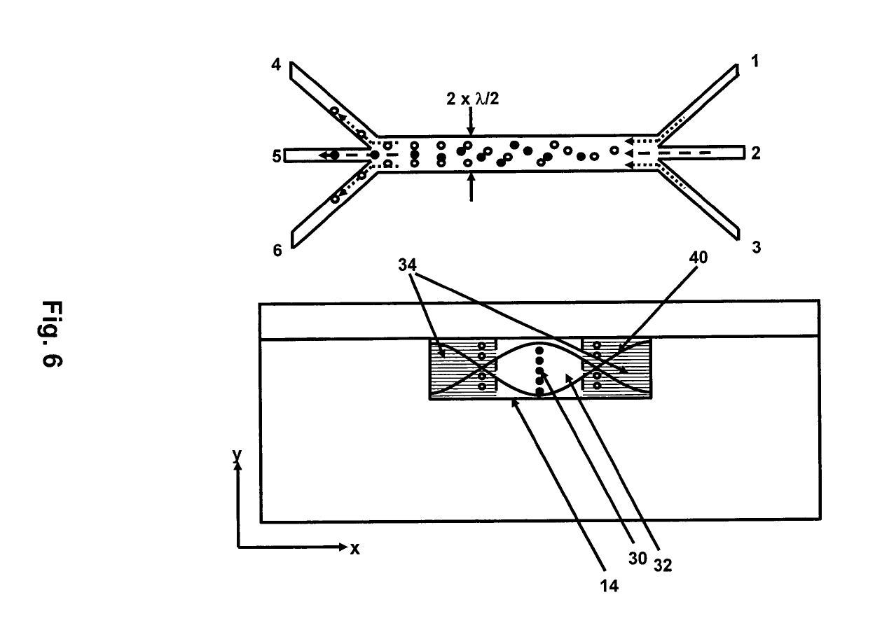

In another embodiment of the invention, shown in FIG. 6, the width of the channel 14 corresponds to two half wavelengths (a first order standing wave 40), such that an anti-node plane 44 is located in the middle of the channel and two node planes 46 are located between the middle of the channel and the side walls. There are three inlets 1, 2 and 3 and three outlets 4, 5 and 6, symmetrically arranged around the centre of the channel. The sample liquid 32 is raw milk, and the sheath liquid 34 has the same density or a higher density than the sample liquid 32, this could for instance be accomplished by dissolving a proper amount of a soluble compound such as sugar, salt or macromolecules which may be protein in water. The flow rates of sample liquid (Q₂) and sheath liquid (Q₁ and Q₃) at the inlet are adjusted such that the sample liquid 32 does not extend beyond the two node planes 44. The fat particles will be drawn towards the central anti-node plane 46, and the somatic cells will be drawn towards the two node planes 44 in the sheath liquid 34. By a proper adjustment of the outlet flow rates Q₄ Q₅ and Q₆, the sheath liquid 34 containing the somatic cells but with absence of other milk components is directed into the two side outlets 4 and 6. The main advantage of this configuration is that the somatic cells are now transferred to a liquid without interfering particles, which facilitates a simple cell counting technology. Another application of this embodiment, is the possibility of concentrating the fat particles in the centre outlet 5, which may be useful for a dedicated fat analysis.

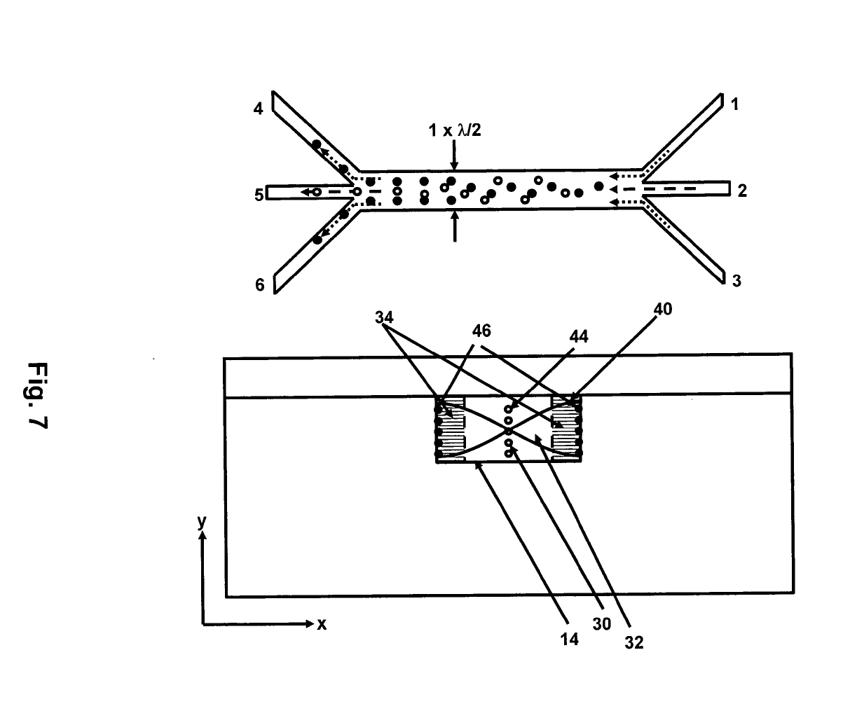

In yet another embodiment of the invention, shown in FIG. 7, the width of the channel 14 corresponds to one half wavelength (a fundamental standing wave 40), such that a node-plane 44 is located in the middle of the channel. There are three inlets 1, 2, and 3 and three outlets 4, 5 and 6, symmetrically arranged around the centre of the channel 14. The sample liquid 32 is raw milk, and the sheath liquid 34 contains a detergent or a non-polar solvent in order to dissolve the fat particles or alternatively the sheath liquid 34 may have a density lower than the fat particles, resulting in a focussing of the fat particles on the liquid boundary 36 between sample liquid 32 and sheath liquid 34. The fat particles are drawn towards the anti-node planes 46 at the channel walls, but the choice of sheath liquid 34 may instead be made from considerations ensuring that the wall is continuously rinsed, the fat particles are dissolved in the sheath liquid 34 or the acoustic forces in the sheath liquid 34 repels the fat particles form the channel wall. The somatic cells are drawn towards the node plane 44 in the middle, and by proper adjustment of the outlet flow rates, the sample liquid 32 containing the somatic cells and a reduced amount of fat particles is directed into the centre outlet 5. The advantage of this configuration is that the resonance quality factor (the Q-value) of the fundamental acoustic resonance is typically higher than for the higher order resonances, such that more acoustic power, and thus stronger forces, can be realized in the channel.

A further embodiment, requires that the difference between sample and sheath liquid in density is small, to avoid an acoustic pressure working on the liquids, destabilising the flow. The practical experience is that less than 10% difference is mostly acceptable, less than 5% difference is preferred, and less than 2% is even more preferred.

A number of different ultrasonic transducers exist, including piezoceramic, piezosalt, piezopolymer, piezocrystal, magnetostrictive, and electromagnetic transducers which may be chosen according to desired capabilities including size, robustness, electronic interface. The wavelength or frequency used for generation of the standing ultrasonic wave also depend on the transducer of choice, as well as the desired separation energy. According to Equation 1 the force on the particles is inversely proportional to the wavelength, and therefore an increased frequency may be beneficial. In practice the range 100 kHz to 10 MHz is a beneficial balance between sufficient separation energy and gentle sample treatment.

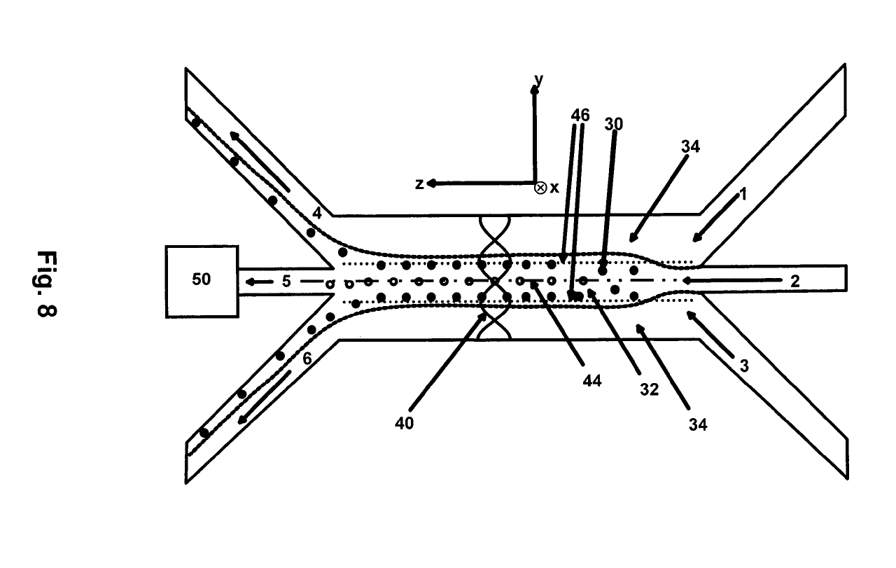

A specific embodiment is the use of the invention in the full or partial removal of fat globules from milk, with the object of detecting and possibly enumerating other particles in the milk. In FIG. 8 this is employed in an embodiment where a milk sample 32 is subjected to removal of the large fat globules, leaving only small fat globules and cells in the central outlet, 5, leading to a device 50 suitable for detecting particles possibly by use of a method such as optical blocking, optical scattering, optical microscopy, phase contrast microscopy, epifluorescence, autofluorescence, impedance or flow cytometry, each having benefits known to the person skilled in the art. Depending on the method of detection, enumeration may be done by counting of particles in a flowing stream, by individual pulses corresponding to each particle or by image analysis of e.g. microscopic images.

### Experiments

Fat particles and somatic cells have been separated in raw milk, using a channel with a width corresponding to 3 times λ/2 and with water as a sheath liquid, using a geometry similar to the one shown in FIG. 6. The fat particles are concentrated at the anti-node planes whereas the somatic cells are concentrated at the node plane in the middle. rᵢₙ is adjusted such that fat particles do not accumulate at the channel side walls, and rₒᵤₜ is adjusted such that the fat particles flow into branches 4 and 6. The sample liquid in the centre outlet has been characterized by FTIR spectroscopy, light scattering and somatic cell counting, as shown in FIGS. 9-12.

The FTIR absorption spectra in FIG. 9 show the case of flow in absence 60 and presence 62 of a standing ultrasonic wave. The figure shows that the fat absorption at approx. 1750 cm⁻¹ is significantly reduced when the ultrasound standing wave is established in the channel. At the same time (not shown here), the absorption peaks at approximately 1520 cm⁻¹ (protein) and 1040 cm⁻¹ (lactose) are practically unaffected, which means that these milk components are not moved, neither is the milk diluted.

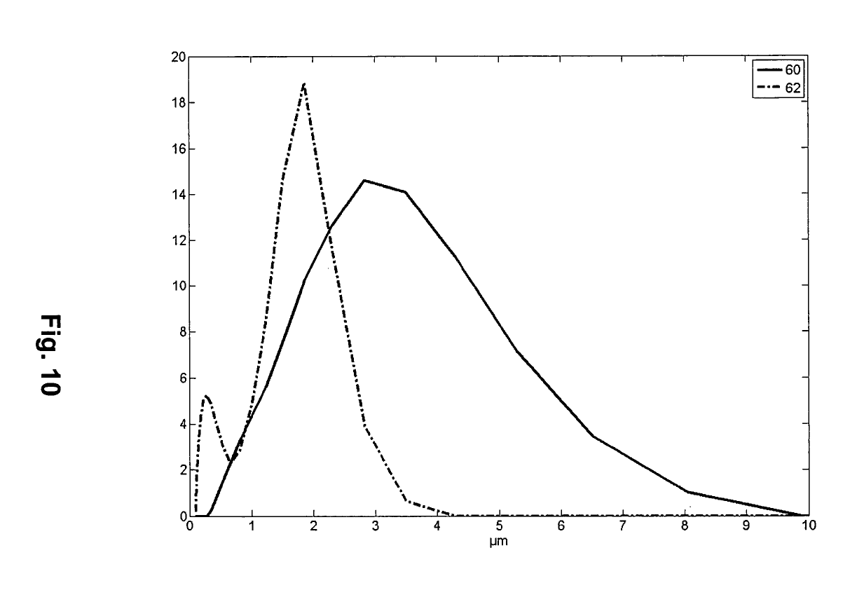

The distribution curves in FIG. 10 show the size distribution (normalized to 100%) of particles in the centre outlet liquid in absence 60 and presence 62 of the ultrasound amplitude is increased. The size distributions were characterized using a light scattering instrument (Malvern Mastersizer). The peak above 1 μm corresponds predominantly to fat particles, and the peak below 1 μm corresponds to casein micelles. As the ultrasound is applied, the peak of the fat particle distribution is found at a smaller particle diameter and at the same time the relative magnitude of the casein peak increases. This is consistent with the FTIR spectra in FIG. 9, that only shows a decrease of the fat content. It is noted that at the highest ultrasound amplitude, there are a negligible number of fat particles left larger than 3 μm. Since somatic cells are typically around 10 μm large, this illustrates the potential of counting the somatic cells without interference from the fat particles.

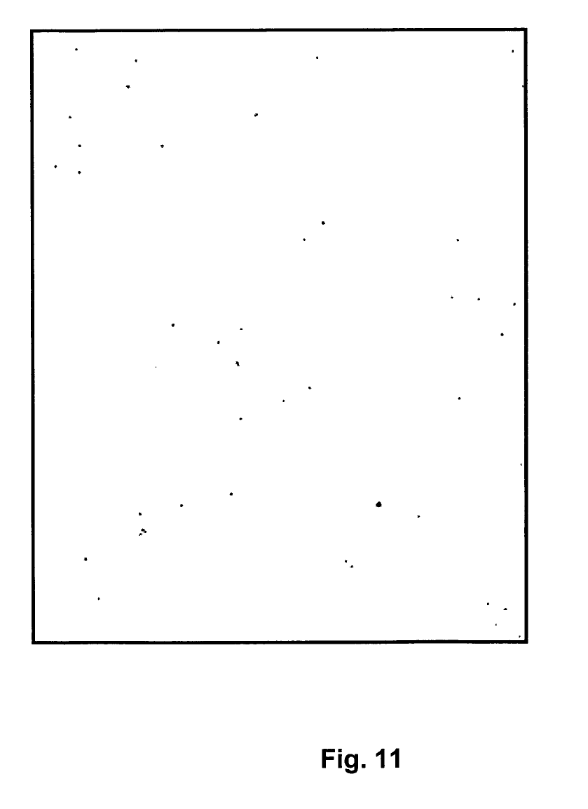

FIG. 11 shows an inverted fluorescence image of the somatic cells present in the sample liquid from the centre outlet, after the ultrasound separation. The number of cells counted is, within statistical limits, identical to the cell count in the bulk raw milk, thus it is demonstrated that cells may be reliably counted by inspection of the sample liquid in the centre outlet.

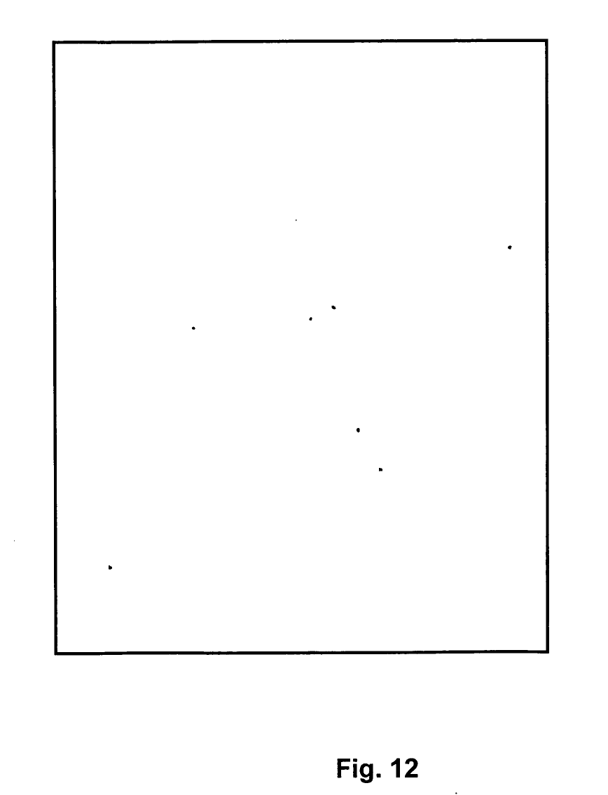

In FIG. 12, a manipulated phase contrast image of the sample liquid from the centre outlet is shown. The image manipulation is includes only the steps of separating the red, green and blue image colour channels and analysing the blue channel only, by applying a threshold for the object size. The image directly shows the presence of somatic cells, and thus demonstrates a label-free detection of the somatic cells, whereas a similar image of untreated milk would not allow detection of somatic cells. FIGS. 11 and 12 are not immediately comparable, as the field of view differs between the images.

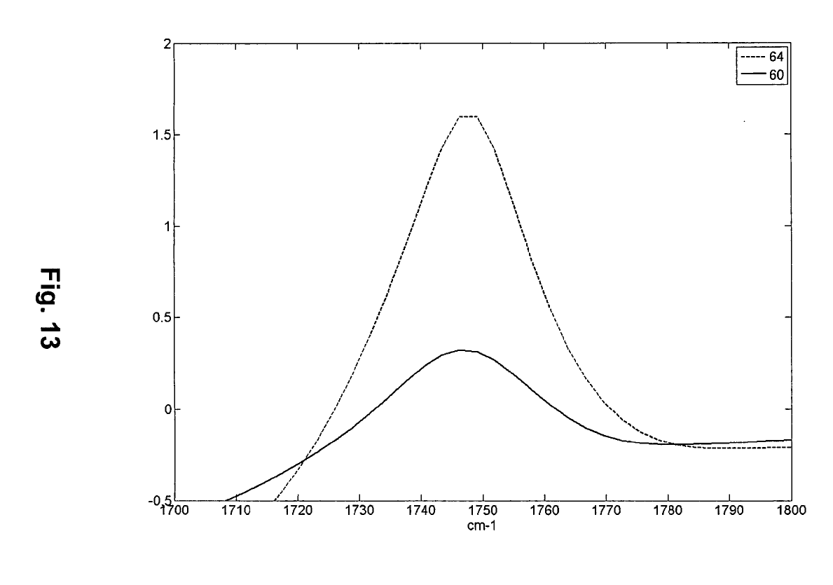

Fat particles in raw milk can be concentrated using a channel with a width corresponding to 2 times λ/2 and a sheath liquid having a density which is similar or higher than that of the sample liquid, using a geometry similar to the one shown in FIG. 6. In the present experiment skimmed milk was chosen as density matched sheath liquid. The fat particles in the raw milk are concentrated at the anti-node plane in the centre. rᵢₙ is adjusted to avoid the raw milk fat particles from sticking to the channel walls, and rₒᵤₜ is reduced as much as possible in order to concentrate the fat in branch 5. In this way, the fat was concentrated at least by a factor 3, as characterized with FTIR, see FIG. 13, where 60 corresponds to the untreated milk and 64 to the milk with concentrated fat. It is important that the sheath liquid has a density close to or higher than raw milk, otherwise the flow may be unstable and the two liquids will tend to exchange position in the channel.

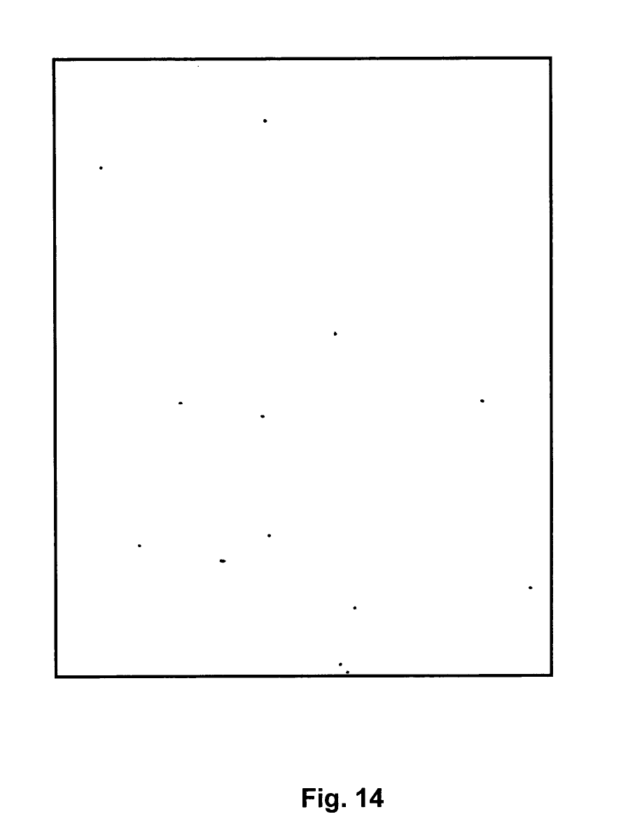

The same geometry described above may also be used in detection of somatic cells, if the liquid in the side outlets is analysed. The fluorescence image in FIG. 14, show the presence of somatic cells in this liquid, and thus demonstrates that the side outlets allow access to the node planes where the somatic cells are concentrated.

1. A method of manipulating particles in a sample liquid said method comprising: flowing the sample liquid at a first flow rate into a compartment having walls dimensioned to support a standing ultrasonic wave of a predetermined wavelength; simultaneously flowing a sheath liquid at a second flow rate into the compartment so as to form a layer of sheath liquid between the sample liquid and the compartment walls;
and while the sample liquid and the sheath liquid are flowing applying ultrasound to the compartment at the predetermined wavelength to focus particles in associated focussing planes of the standing ultrasonic wave; wherein the predetermined wavelength and first and second flow rates are selected such that the liquids flowing through the compartment are subjected to a standing ultrasonic wave having an anti-node plane in the direction of flow and located within the sheath liquid and in that flowing the sheath liquid comprises flowing a sheath liquid having a density relative to the sample liquid selected to inhibit the interchange of the sheath liquid and the sample liquid within the compartment during the application of the ultrasound.

2. A method as claimed in claim 1 wherein the difference in density between the sheath liquid and the sample liquid is less than 10%, preferably less than 5% and more preferably less than 2%.

3. A method as claimed in claim 1 wherein the step of flowing a sheath liquid comprises flowing a sheath liquid having a density lower than the lowest density particles in the flowing sample liquid.

4. A method as claimed in claim 1 characterised in that the step of flowing a sheath liquid comprises flowing a sheath liquid comprising a detergent.

5. A method as claimed in claim 1 wherein the step of flowing a sheath liquid comprises flowing a sheath liquid comprising a non-polar solvent.

6. A method according to claim 1 wherein there is further provided a step of selectively collecting the particles focussed in associated focussing planes at different outlets of the compartment; said step of selectively collecting the particles including the step of adapting flow rates of the sample liquid and the sheath liquid out of the compartment to direct the flow of each of these liquids corresponding to a focussing plane to different specific outlet channels.

7. A method as claimed in claim 1 wherein the sample liquid consists of milk having fat particles.

8. An arrangement for manipulating particles in a sample liquid said arrangement comprising a compartment having an inlet for a sample liquid, an inlet for a sheath liquid and one or more outlets separated from the inlets along a length axis of the compartment, the compartment being dimensioned to support a standing ultrasonic wave of a predetermined wavelength having focusing planes parallel to the length axis of said predetermined wavelength; a source of ultrasound adapted to operate to emit ultrasound of the predetermined wavelength into the compartment; and a source of sheath liquid connectable to the inlet for sheath liquid wherein the arrangement further comprises means for establishing a relative flow of sheath liquid and of sample liquid into the compartment at flow rates dependent on the predetermined wavelength such that in use an anti-node focusing plane is 20 located within the sheath liquid flowing through the compartment;
and in that the source of sheath liquid contains a sheath liquid having a density relative to the sample liquid selected to inhibit the interchange of the sheath liquid and the sample liquid within the compartment during operation of the ultrasound source.
